(19) United States
(12) Patent Application Publication
(10) Pub. No.: US 2026/0044758 A1
(43) Pub. Date: Feb. 12, 2026

(54) CAUSALLY AWARE EDGE-DEPLOYABLE MACHINE LEARNING MODELS AND SYSTEMS

(71) Applicant: CausaliT LLC, Portland, OR (US)

(72) Inventors: Ganapati Narayana Srinivasa, Portland, OR (US); Hollis Jefferey Wright, Portland, OR (US); Olivia Hunter Webber, Tualatin, OR (US)

(21) Appl. No.: 19/293,828

(22) Filed: Aug. 7, 2025

Related U.S. Application Data
(60) Provisional application No. 63/680,762, filed on Aug. 8, 2024.

(51) Int. Cl. G06N 20/00

(52) U.S. Cl. CPC G06N 5/045

(57) ABSTRACT

A system for generating and deploying savant language models that operate in conjunction with a directed acyclic graph. In some cases, a first stage cloud-based system may utilize large language models and domain specific directed acyclic graphs to generate deployable models. The deployable models may include the savant language models and sub-domain directed acyclic graphs that may operate in computational resource restricted environments.

### CROSS-REFERENCE TO RELATED APPLICATIONS

This application claims priority to U.S. Provisional Application No. 63/680,762 filed on Aug. 8, 2024 and entitled “Causally Aware Edge-DEPLOYABLE machine learning models and systems,” the entire contents of which are incorporated herein by reference.

### BACKGROUND

Today, large language models for use in machine learning and artificial intelligence solutions display seemingly human-like reasoning and response capabilities. However, these large language models are fundamentally token correlative predictors and provide little to no human insight into the actual structure of the model itself. Today, large language models, due to erroneous correlations and/or mis-predictions resulting from the correlative prediction training, self-training, and implementation, are prone to hallucinations and drift. Further, due to the lack of human insight and control into the base structure of the model, correcting or debugging the resulting hallucinations and drift is difficult to impossible.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a system for generating and deploying savant language models according to some implementations.

FIG. 2 is another example block diagram of a system for generating and deploying savant language models according to some implementations.

FIG. 3 is another example block diagram of a system for generating and deploying savant language models according to some implementations.

FIG. 4 is an example block diagram associated with the causal substructure and savant language model generation system of FIG. 3 according to some implementations.

FIG. 5 is another example block diagram associated with the causal substructure and savant language model generation system of FIG. 3 according to some implementations.

FIG. 6 is yet another example block diagram associated with the causal substructure and savant language model generation system of FIG. 3 according to some implementations.

FIG. 7 is a flow diagram illustrating an example process associated with the generation and deployment of savant language models, according to some implementations.

FIG. 8 is an example cloud-based system that may implement the techniques described herein according to some implementations.

FIG. 9 is an example hardware device for deployment of a savant language model according to some implementations.

### DETAILED DESCRIPTION

Recent advances in large language models (LLMs) have resulted in solutions that approach general purpose use and display seemingly human-like reasoning capability. However, these conventional LLMs are based on a token correlative prediction that results in opaque operations and insight into the LLM's actual structure. The lack of insight into the model's reasoning, structure, and operations results in models and implementations that are prone to issues, such as hallucination and drift, that are difficult to understand and debug. For example, conventional LLMs are more akin to the statistical methods wherein correlation and/or association are the primary metric used to generate an output of the LLM. Accordingly, the structure of a conventional LLM is a multi-billion parameter regression-like model that attempts to predict a next token in a sequence of tokens given an input and the preceding sequence of tokens without consideration for causal data. In some cases, bias introduced during pre-training of conventional LLMs may act as confounder that causes incorrect answers and exacerbates issues associated with hallucinations, such as due to spurious correlations.

Often the presence of or merely the risk of hallucinations and drift in conventional machine learning models (MLM) such as LLMs, limit their practical application and uses in many industries, such as healthcare and manufacturing. For instance, imprecise or erroneous outputs in these high-trust industries and applications have direct and profound adverse consequences, such as damage to the health of a patient or failure of the manufactured component. These issues relating to hallucination and drift experienced in conventional LLMs are exacerbated by a lack of source-tracing by the LLMs or the ability for the LLMs to reliably reason back to a root cause of an output. In other words, the conventional LLMs fail to provide any insight into the explanation of how a conclusion or output was reached except in terms of their internal, non-causal parameters, particularly in complex situations. Accordingly, the opaque operations and presence of hallucinations and drift limit conventional LLMs applicability particularly in high-trust applications and industries.

Additionally, conventional LLMs are typically dependent on having access to powerful computational infrastructure, such as a large number of computational resources available via cloud computing environments. The need to access the cloud based computational infrastructure often limits the applicability of LLMs in low power or edge deployments, where the availability of computing hardware or network connectivity is limited or unreliable. The conventional LLM's reliance on cloud resources also raises concerns relating to privacy and security in various industries, including but not limited to healthcare and financial applications, and also increases vulnerabilities of critical infrastructure to malicious intent or flawed systems.

The system, process, and models discussed herein, utilize causal modeling with LLMs to address many of the issues of existing conventional correlative approaches (e.g., hallucinations, drift, debuggability, opaque operations, dependency on cloud-computing resources, and the like) by generating MLMs that implement an understandable and accessible base structure and, provide explainable and reproducible reasoning structures that are more trustworthy and less prone to drift and hallucination than conventional LLMs. Additionally, the systems, processes, and models, discussed herein, enable extraction of simpler sub-models that may be edge-deployed as self-contained MLMs that are contextually adaptive to a specific local environment or deployment (e.g., a specific person's medical history, a specific device's operations, a specific ongoing collection of sensor data, or the like).

In some implementations, systems, architecture, and processes, for generating, deploying, and utilizing machine learning models that provide a user accessible base structure that may be accessed and debugged to control, limit, reduce, and/or correct issues with the underlying MLMs, such as hallucination and drift are discussed herein. For example, the system may include a two-stage cyclical process or methodology for generating and deploying causally based MLMs or artificial intelligence (AI), such as an AI agent. In some cases, the two-stage cyclical process may utilize one or more large language models (LLMs) within the first stage. During the first-stage, the process may integrate domain specific (e.g., industry, organization, individual, or the like) causal data (e.g., knowledge) and multi-modal data streams (e.g. text data, image data, sensor data, or the like) to model and infer causal relationships (“causal discovery”) between the causal data that may be represented as a structure (e.g., graphs, model, MLMs and/or the like).

For example, the structure used to represent the domain specific causal data may be in the form of a directed acyclic graph (DAG). A DAG may be represented as a mathematical structure of nodes and connections or edges. As the DAG is a directed graph, the connections or edges flow from one node to another in a manner (and are often represented as having arrows) that indicate directionality. In the current implementation (e.g., the use of causal influence in the form of a DAG), an example of an edge from A to B means A causes B. In some cases, the DAG are also acyclic which implies that causes do not eventually flow back on themselves. In this manner, the DAG is a way of describing qualitative causal relationships among variables within a given domain. The DAG, discussed herein, may in some cases be considered less detailed than a full model description but contains causal information that a purely statistical model or conventional LLM does not. Unlike a statistical model, a DAG represents and informs the consequences of intervening to change a variable, within the limits of the correctness of the DAG itself.

The DAG for each domain is constructed out of four types of basic structures. These four basic structures that may be represented in a DAG for a given domain may include the Fork, the Pipe, the Collider, and the Descendant. The Fork may be represented as A←B→C. The Pipe may be represented as A→B→C. The Collider may be represented as A→B←C. The Descendant may be represented as X→Z and Y→Z→D. As the system and process may open and close each node, a user or computational system is capable of selecting variables to include or not include while using “do calculus” or performing predictions, the effect of interventions on any variable or performing counterfactual analysis.

During the first stage the domain specific DAGs and the LLMs may be utilized (such as in a feedback loop) and causes the LLMs to utilize the causal data of the DAGs for the generation of small causal structures (e.g., smaller or more specialized DAGs) associated with the domain or a sub-domain. The specialized DAGs or causal structures may then be utilized to generate one or more smaller task-specific instances of the model that may operate within the domain (herein “savant language models” or “SLMs”). In this example, the SLMs generated by the causal information LLMs (e.g., the combination of the domain specific DAGs and LLMs) allows for the generation of seed SLMs that include a smaller machine learning models and specialized DAGs.

The SLMs (including the seed SLMs) are configured for a reduced computational load compared with LLMs and are suitable for edge deployments while still retaining the benefits of using causal models as a basis. The SLMs are further configured to adapt themselves at and to the environment of deployment thereby integrating specific circumstances of the local environment or tasks (herein “contextual adaptation”) while also providing feedback to the first-stage model to contribute to a cycle of model improvement.

Once the causal sub-structures (e.g., the specialized DAGs) and the seed SLMs are generated for a specific environment, operational device, or task, the seed SLMs may be deployed as the second stage of the two-stage process. For instance, the SLMs together with the specialized DAGs may be deployed on edge computing, user devices, autonomous systems, and the like to perform a specific task or operate within a specific environment associated with the domain. As an illustrative example, the seed SLMs may be generated for edge deployment at a potato processing facility to monitor the quality of the potatoes prior to processing. The seed SLMs and the specialized DAGs may then, during the second stage, operate in a feedback loop based on the sensor data or image data captured by the edge device, adjusting one another based on the performance and output of the other and thereby learning to differentiate between usable and unusable potatoes. In some cases, the DAG structure may be considered a semantic rule-based memory or model and the SLM structure may be considered an episodic event memory or model.

As discussed herein, causal inference structure (e.g., the DAGs operating in conjunction with the LLMs and SLMs) goes beyond an association of two nodes and determines or identifies a causal effect when the state of a variable A affecting a downstream variable B is altered by chance and/or deliberate intervention and thereby alters the state of B based on the change in A. In this manner, causal modeling provides a framework to interpret causal effects from real-world data in a useable manner, addressing the fundamental issues of lack of explainability and root-cause determination within statistical MLMs and/or LLMs. In some cases, the systems and models, discussed herein, may integrate uncertainties resulting from causality into the models resulting from the two-stage process, such that noisy data signals may be extracted and a confidence of causal inference quantified (e.g., a weight determined and applied).

Between the first stage and second stage, the process may include a handoff from the cloud-based system to the local hardware (e.g., a deployment). In some cases, the handoff includes generation of a causal sub-domain DAG model by the causal discovery system (e.g., the LLMs and domain DAGs), and extraction of a seed SLM sub-model incorporating the sub-domain DAG from a causal evaluation model after the causal evaluation model has been trained on the sub-domain DAG DAG.

In some examples, the first stage may include a system (such as a cloud-based system) that may receive domain data for a specific domain (e.g., industry, process, workflow, or the like). One or more first LLMs may be configured to perform causal discovery on domain specific data to integrate the domain specific data and output one or more domain specific DAGs. Once initial domain DAGs are generated by the one or more first LLMs, the cloud-based system may perform causal evaluation. During causal evaluation, one or more second LLMs may be utilized to input the domain specific DAGs and output updated domain specific DAGs, such as in some examples via a feedback loop. In some cases, the one or more second LLMs may perform causal substructure and SLM generation to generate the sub-domain DAG and/or one or more seed SLMs. The SLM generation and optimization may include, for example, utilizing the one or more second LLMs to perform sub-domain DAG generation to generate the sub-domain DAGs and to generate the seed SLM (such as a single seed SLM or a set of seed SLMs).

In some examples, the seed SLM generation may include use of one or more techniques (such a training, distilling, or specialization techniques). For example, the techniques may include a group relative policy optimization (GRPO) technique, an ask-refine-trust (ART) technique, a train-distill (DISTILL) technique, and/or the like.

The GRPO technique may include prompting an input model for a group of proposed solutions which may then be evaluated by one or more reward checker systems. In some cases, the reward checker system may, based at least in part on provided rewards, update the SLM's model's parameters to increase the likelihood of producing the desired results. This process may be iterated until a tuning threshold is meet or achieved and/or a predetermined number of iterations are performed. In some examples, this technique or process may generate a refined model (SLM) that is the substantially the same size as the input model.

In some implementations, an unrefined LLM may be prompted for potential DAG structures. The output DAG structures may then be evaluated based at least in part on the defined rewards using the reward checker systems. In some cases, the evaluation may include simple checks and complex checks. The output of the evaluation may then be provided back to the one or more second LLM to cause the one or more second LLM to further specialize in the desired domain or sub-domain. The process may then be performed again, outputting DAGs that become more and more domain specialized thereby generating the seed SLM over multiple iterations.

As another example, the ART technique may include may be utilized to generate the seed SLMs. The ART technique may be utilized to generate smaller SLMs that may be configured to operate on resource constrained hardware components. In some cases, the ART technique may begin with a “small” unrefined LLM (e.g., an LLM having approximately 100 million to one billion parameters). The unrefined LLM may then utilize an ask-refine-trust process to learn the domain DAGs and/or the sub-domain DAG. In some cases, the ART technique may employ a larger LLM, such as a third LLM to generate ranked answers to individual answers output by the SLM in training that fail to match the input or training data (such as a predefined sub-domain table or database). The SLM in training may undergo multiple rounds or iterations of refinement (e.g., training via ranked answers to unmatching or unanswered questions) to generate the seed SLM.

The DISTILL technique may again utilize an unrefined LLM (such as a full size or larger LLM having approximately 70 billion or more parameters) trained utilizing standard techniques to learn the domain DAGs and any associated tasks. Next, the DISTILL technique may be trained using sub-domain questions and the sub-domain DAG. In some cases, the DISTILL technique may cause the larger LLM to distill or reduce in size for each round or iteration as the LLM is trained on the sub-domain DAG to ultimately generate the seed SLM.

When the sub-domain DAG and the seed SLM are integrated on a deployment system, the seed SLM can learn from data generated by the deployment system independently of the cloud-based system. Accordingly, in the second stage (e.g., deployment), the seed SLM and Causal sub-domain DAG adapt to the specific environment accumulating knowledge based on the results of applying the sub-domain DAG during operation into the SLM. Once the SLM acquires enough local data, the SLM representation becomes richer and adapted to the specific deployment (e.g., the deployed SLM has acquired episodic memory in addition to the semantic memory embedded in it during creation).

In some cases, a second stage SLM may provide feedback to the cloud-based system to enrich the capabilities of the cloud-based system. In some cases, the feedback may be in the form of a causal DAG, which reduces concerns relating to data privacy and security as only local model structures and confidence inferences are transmitted to the cloud system; no actual local data is provided back or transmitted to the cloud-based system. As an illustrative example, the SLM and sub-domain DAG together execute tasks and operations (e.g., monitoring a manufacturing device) by a combination of the semantic memory (inherited in the sub-domain DAG) and episodic memory (based on the SLM seed-training and self-training). The model can further perform (e.g., determine root causes) model analysis to determine a likely cause of a malfunction or error (such as a hallucination or drift). In some cases, depending on the output of the model analysis (as input by a user or by inference on future errors), the SLM and the sub-domain DAG may be adjusted to take verifiable root causes into account. In this manner, unknown variables may be incorporated into the learning system at the edge deployment (such as via a missingness graph applied to the DAG upon which the existence and identity of the unknown variables is inferred and identified, or via specific input from local expert users). The cloud-based system may improve representation of input data and causal data within the causal discovery phase. The extraction process and internal structure of the seed SLM models depend on both the implementation needs and available compute resources for a particular deployment model (e.g. pure causal network, LLM-embedded causal network, Kolmogorov-Arnold network, single larger vs. ensemble of smaller voting models, or the like). The process allows for the enablement of efficient feedback and transfer learning between edge-deployed SLMs while preserving contextual adaptations in the SLMs.

In some cases, the system discussed herein introduces and improves fairness while reducing bias associated with deploying language models. In conventional pretrained language models, bias is particularly common as the conventional pretrained language models captures and often amplifies undesired or unidentified bias within the training data set, e.g. social stereotypes knowingly or unknowingly contained within the corpus of data used to pretrain and/or train the conventional LLM. An example of bias in language models includes gender associations with specific professions, such as male firefighters and female nurses. The causality-based methodologies, discussed here, offer an approach for mitigating these biases in language models by discerning an origin of each bias through the causal structure. Once identified, bias mitigation may follow via the eliminating of the unwanted spurious correlation between generative factors (e.g. by utilizing the DAG information as an adjustment to the identified bias when training, constructing, evaluating or extracting sub-models from the model; by weighting gender correlation with particular professions by the causal effect (or lack thereof) of gender upon that profession indicated by the causal DAG's structure).

In some implementations, the first stage processing associated with generating the domain specific causal structures DAGs and SLMs by the causal aware LLMs may be performed in the cloud using larger available resource pools. The defined or generated seed SLMs may then be deployed as the second stage on local hardware (such as for use in edge computing applications). The SLMs may then integrate (e.g., self-train for the specific task or environment) using data captured or generated by the local hardware to thereby train as a specialized SLM for a specific task or environment.

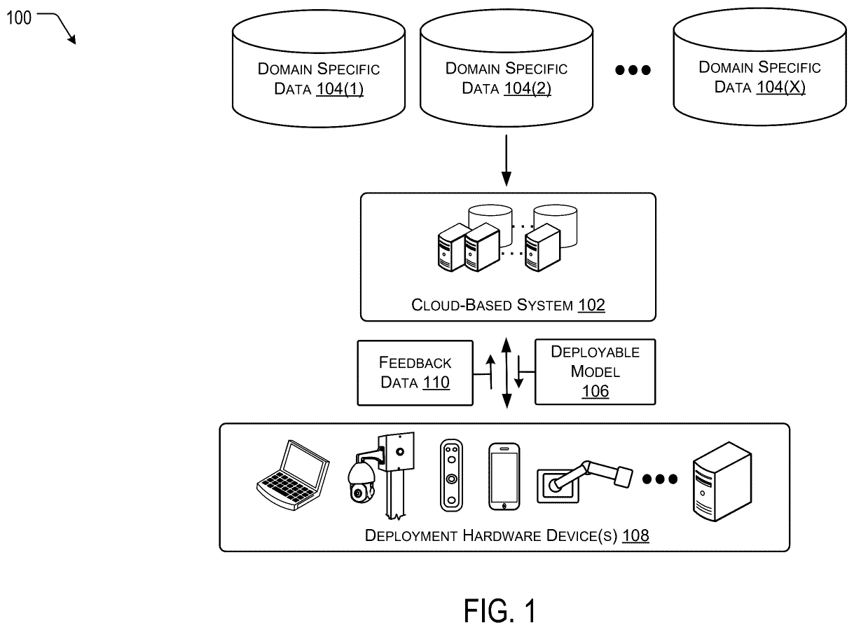

FIG. 1 is an example block diagram of a system 100 for generating and deploying savant language models according to some implementations. In the current example, a first stage cloud-based system 102 may be configured with one or more first LLMs. The one or more first LLMs may be configured to perform causal discovery on domain specific data, such as domain specific data 104(1)-(X) in the illustrated example. As discussed herein, during the causal discovery, the cloud-based system 102 may be configured to integrate knowledge (e.g., the domain specific data 104) that is discovered using knowledge extraction by the one or more first LLMs from text data, preexisting expert knowledge data, multi-modal data streams (e.g., text, images, sensor data), and the like. The integrated knowledge may be represented or output as one or more domain specific DAGs. As discussed above, a DAG may be a mathematical structure of nodes and connections or edges representing a directionally informed causal relationship between the nodes.

Following causal discovery, the cloud based system 102 may perform causal evaluations of the domain specific DAGS. For example, the domain specific DAGs and one or more second LLMs may be utilized (such as in a feedback loop) and cause one or more second LLMs to utilize the causal data of the domain specific DAGs for the generation of small causal structures (e.g., smaller or more sub-domain DAGs) associated with a sub-domain (e.g., smaller task, smaller environment, smaller problem, or the like) associated with the large domain.

The cloud-based system 102 may then utilize the sub-domain DAGs to generate one or more smaller task-specific instances that may operate within the domain (herein “savant language models” or “SLMs”). In this example, the SLMs generated by the causal information LLMs (e.g., the combination of the domain specific DAGs and LLMs) allows for the generation of a deployable model 106 that includes a seed SLMs and one or more sub-domain DAGs.

In the illustrated example once the deployable model 106 is generated for a sub-domain specific task or use, the deployable model 106 may be installed or otherwise hosted by a deployment hardware device 108. In this manner, the SLMs (including the seed SLMs) of the deployable model 106 is configured for a reduced computational load compared with LLMs and are suitable for edge deployments while still retaining the benefits of using causal models (e.g., the sub-domain DAGs) as a basis. The SLMs are further configured to adapt themselves at and to the environment of deployment (e.g., the deployment hardware devices 108) thereby integrating specific circumstances of the local environment or tasks while also providing feedback 110 (such as the adjusted DAG and/or SLM model structure and weights based upon local adaptation) to the first stage cloud-based system 102 to contribute to a cycle of model improvement (e.g., LLM and domain specific DAG improvement).

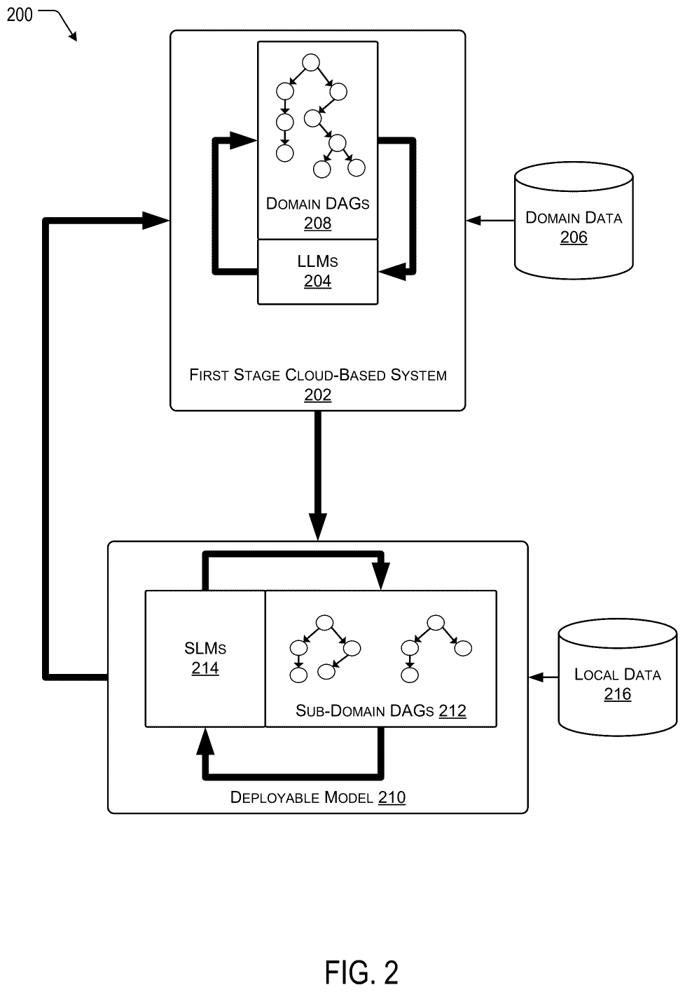

FIG. 2 is another example block diagram of a system 200 for generating and deploying savant language models according to some implementations. In the current example, a first stage cloud-based system 202 may again be configured with one or more LLMs 204. The one or more LLMs 204 may be configured to perform causal discovery on domain specific data 206. As discussed herein, during the causal discovery, the LLMs 204 may be configured to integrate knowledge (e.g., the domain specific data 206) and output one or more domain specific DAGs 208. In the current example, the LLMs 204 and the domain DAGs 208 may operate in a feedback loop to improve the operations of the LLMs and the structure of the domain DAGs 208.

Following causal discovery, the cloud-based system 202 may perform causal evaluations of the domain specific DAGS 208. For example, the domain specific DAGs 208 and one or more LLMs 204 may be utilized to generate a deployable model 210 including one or more sub-domain DAGs 212 and a seed SLM 214. The seed SLMs are configured for a reduced computational load compared with LLMs and are further configured to adapt themselves (e.g., via self-learning or data integration) at and to the environment of deployment, thereby integration specific circumstances of the local environment or tasks can contribute to a cycle of improvement.

As discussed above, the deployable model 210 may be installed or otherwise hosted by local hardware devices, such as edge computing, personal computing, sensor systems, autonomous systems, and the like. For example, when the sub-domain DAG 212 and the seed SLM 214 are integrated on a deployment system, the seed SLM 214 may learn from local data 216 generated by the deployment system (e.g., the local hardware, such as user inputs, sensor data, device operational data, and the like) independently of the cloud-based system 202. Accordingly, during deployment, the seed SLM 214 and sub-domain DAG 212 adapt to the specific environment, accumulating knowledge based on the results of applying the sub-domain DAG 212 during operation into the SLM 214. Once the SLM 214 acquires enough local data 216, the SLM 214 representation becomes richer and adapted to the specific deployment (e.g., the deployed SLM 214 has acquired episodic memory in addition to the semantic memory embedded in it during creation).

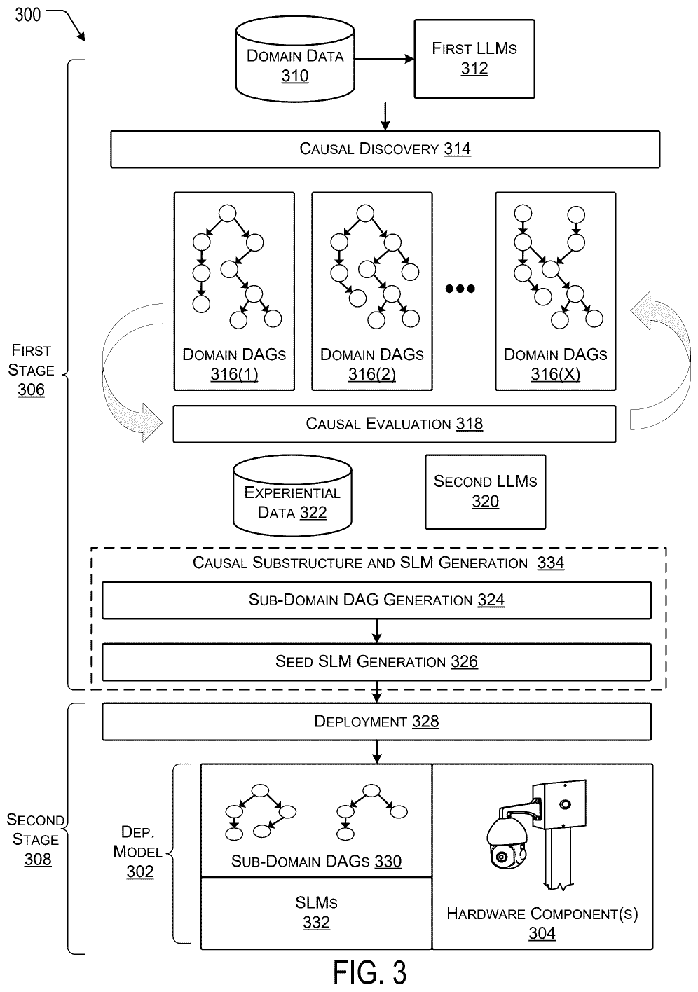

FIG. 3 is another example block diagram of a system 300 for generating and deploying savant language models according to some implementations. As illustrated, the generation and deployment of the deployable model 302 on hardware components 304 includes a first stage 306 and a second stage 308. The first stage 306 may be performed in the cloud and take advantage of the large computational resources provided by cloud-based computing systems to generate the deployable models 302 and the second stage 308 may be configured to allow for deployment that is operational under reduced or restricted computational resources (e.g., deployment to hardware components 304 on a closed-system or edge-based device).

During the first stage 306, a cloud-based system may receive domain data 310 for a specific domain (e.g., industry, process, workflow, or the like). One or more first LLMs 312 may be configured to perform causal discovery 314 on domain specific data 310 to integrate the domain specific data 310 and output as one or more domain specific DAGs 316(1)-(X). Once initial domain DAGs 316 are generated by the one or more first LLMs 312, the cloud-based system may perform causal evaluation 318.

During causal evaluation 318, one or more second LLMs 320 may be utilized to input the domain specific DAGs 316 and output updated domain specific DAGs 316, such as in some examples via a feedback loop on received experiential data 322 (e.g., sensor data from internal or external sensors, quality feedback from external human or automated quality evaluations). During causal evaluation 318, the one or more second LLMs 320 may perform causal substructure and SLM generation 334 to generate the sub-domain DAG and/or one or more seed SLMs 332. The SLM generation and optimization 334 may include, for example, utilizing the one or more second LLMs 320 to perform sub-domain DAG generation 324 to generate the sub-domain DAGs 330, as discussed herein. The one or more second LLMs (or one or more third LLMs) may also perform seed SLM generation 326 to generate one or more seed SLMs 332 (such as a single seed SLM or a set of seed SLMs) using the sub-domain DAGs 330, the domain DAGs 316, and data associated with the specific task, environment, process, or the like.

In some examples, the causal substructure and SLM generation 334 may include various different techniques that may be applied individually and/or in combination to generate the sub-domain DAGs 330 and the SLMs 332 for deployment 328 to one or more specialized hardware components 304. For example, the seed SLM generation 326 may include use of group relative policy optimization (GRPO) techniques, an ask-refine-trust (ART) technique, a train-distill (DISTILL) technique, and/or the like.

For instance, the GRPO technique may include prompting an input model for a group of proposed solutions which may then be evaluated by one or more reward checker systems. In some cases, the reward checker system may, based at least in part on provided rewards, update the SLM's model's parameters to increase the likelihood of producing the desired results. This process may be iterated until a tuning threshold is meet or achieved and/or a predetermined number of iterations are performed. In some examples, this technique or process may generate a refined model (SLM) that is the substantially the same size as the input model.

In some implementations, during the causal substructure and SLM generation 334, an unrefined LLM may be prompted for potential DAG structures. The output DAG structures may then be evaluated based at least in part on the defined rewards using the reward checker systems. In some cases, the evaluation may include simple checks, such as “does the graph only contain nodes that have been specified,” “is the graph acyclic,” “is the graph connected,” and/or the like. The evaluation may also include more complex checks, such as “does the DAG conform to the defined or discovered graph structure,” “is the graph consistent with experiential data provided,” and/or the like. The output of the evaluation may then be provided back to the LLM to cause the LLM to further specialize in the desired domain or sub-domain. The process may then be performed again, outputting DAGs that become more and more domain specialized.

In some cases, the unrefined LLM may be initially provided the output of the sub-domain DAG generation 324 and the subdomain DAGs 330 and the seed SLMs 332 may be generated as part of the iterative process associated with the GRPO process. Accordingly, in some example, the sub-domain DAGs and the SLMs 332 may be generated in tandem as an iterative process further refining the sub-domain specialty of the SLMs 332 at each iteration.

As another example, the ART technique may include may be utilized to generate the sub-domain DAGs 330 and/or the SLMs 332 as part of the causal substructure and SLM generation 334. In some cases, the ART technique may be utilized to generate smaller SLMs 332 or SLMs 332 that may be configured to operate on resource constrained hardware components 302.

In some cases, the ART technique may begin with a “small” unrefined LLM (e.g., an LLM having approximately 100 million to one billion parameters). The unrefined LLM may then utilize an ask-refine-trust process to learn the sub-domain DAG 330. In some cases, the ART technique may employ a larger LLM, such as the one or more second LLMs 320 to generate ranked answers to individual answers output by the SLM in training that fail to match the DAG 330 or other input data (such as a predefined sub-domain table or database). The SLM in training may undergo multiple rounds or iterations of refinement (e.g., training via ranked answers to unmatching or unanswered questions) to generate the SLM 332.

As yet another example, the DISTILL technique may include may be utilized to generate the sub-domain DAGs 330 and/or the SLMs 332 as part of the causal substructure and SLM generation 334. In this example, an unrefined LLM (such as a full size or larger LLM having approximately 70 billion or more parameters) trained utilizing standard techniques to learn the domain DAGs 316 and any associated tasks for the specific use case of the SLM 332. Next, the DISTILL technique may be trained using sub-domain questions and either the sub-domain DAG 330 and/or other input data (such as a predefined sub-domain table or database). In some cases, the input data may be used to generate initial predictions which may be input into the unrefined LLM or the SLM in training to distill or reduce the size of the unrefined LLM or the SLM in training. In various examples, multiple rounds or iterations of refinement (e.g., training via rounds of predictions) to generate the SLM 332 or in other words each round or iterations may further distill the SLM in training until the desired SLM 332 is obtained.

Once both portions of the deployable model 302 are generated (e.g., the seed SLMs 332 and the sub-domain DAGS 330), the second stage may be implemented and deployment 328 on the hardware components 304 may be performed. One deployed, the SLM 332 of the deployable model 302 may integrate local data generated by the hardware components, such as user inputs (natural language inputs, user interface devices inputs, and the like), local sensor data, operational data of the hardware components 304, and the like, thereby improving the SLM 332 and specializing the sub-domain DAGS 330 for the given sub-domain task on the hardware components 304.

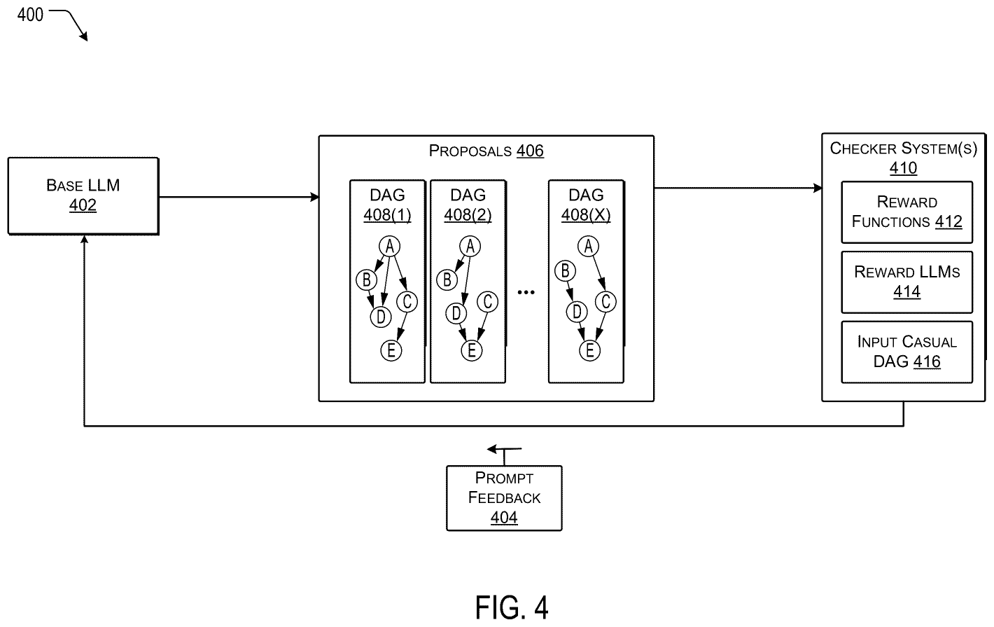

FIG. 4 is an example block diagram associated with the causal substructure and SLM generation system 400, such as the causal substructure and SLM generation system 334 of FIG. 3 according to some implementations. In the current example, the causal substructure and SLM generation system 400 may utilize the GRPO technique discussed herein. For example, the system 400 may begin with an unrefined or base LLM 402. Initially, the base LLM 402 may receive inputs in the form of prompts or prompt feedback 404. The prompt feedback 404 may prompt or request the base LLM 402 to output a group of proposed solutions or proposals 406.

The proposals 406 may be in the form of one or more DAG, such as the illustrated DAGs 408(1)-408 (X). The proposals 406 including the DAGs 408(1)-408 (X) may then be evaluated by one or more reward checker systems 410. In some cases, the reward checker systems 410 may, based at least in part on provided rewards, evaluated the proposals 406, and then update the base LLM 402 (e.g., the SLM in training) model parameters to increase the likelihood of producing desired results as determined by the checker systems 410. For instance, the checker system 410 may include one or more reward functions 412, one or more reward LLMs 412, and an input causal DAG 414, such as the domain DAGs 316 generated as part of the first stage 306 discussed above with respect to FIG. 3.

In some implementations, the proposed DAG structures 408 may be evaluated by the reward functions 412 and the reward LLMs 414 based at least in part on the input causal DAG 416 to generate the prompt feedback 404 for the next iteration of specialization. In some cases, the evaluation may include simple checks, such as “does the graph only contain nodes that have been specified,” “is the graph acyclic,” “is the graph connected,” and/or the like. The evaluation may also include more complex checks, such as “does the DAG 408 conform to the defined or discovered graph structure,” “is the graph consistent with experiential data provided,” and/or the like.

In the illustrated example, the checker systems 410 may evaluate the proposals 406 and determine the prompt feedback 404 to provide to the base LLM 402 (e.g., the SLM in training) for the next iteration or round of training for the base LLM 402 (e.g., the SLM in training). Accordingly, the process may be iterated until a training or tuning threshold is met or achieved and/or a predetermined number of iterations are performed. In some examples, this GRPO technique or process may generate a refined SLM from the base LLM 402 that is the substantially the same size as the input base LLM 402.

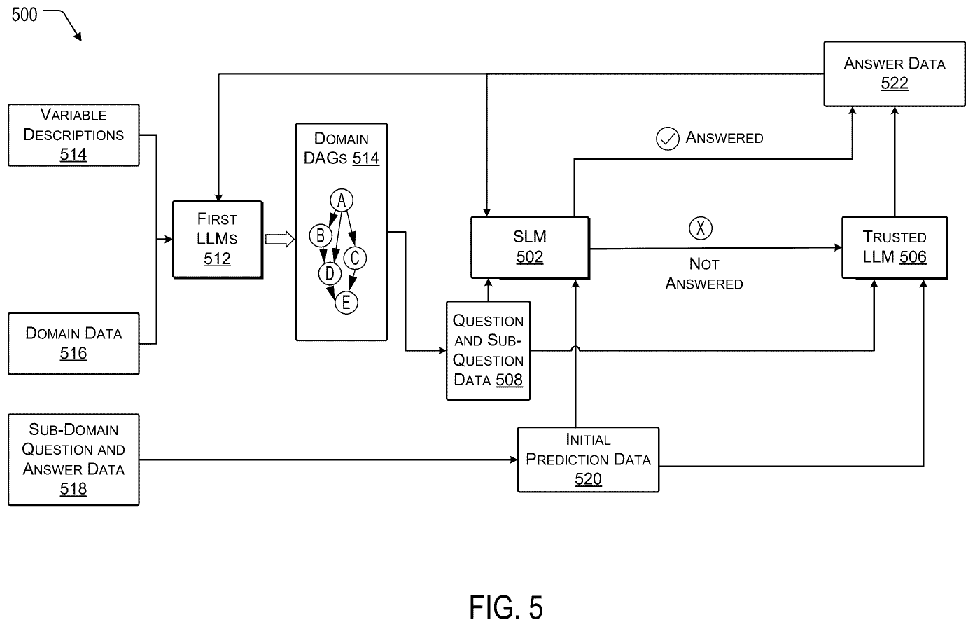

FIG. 5 is another example block diagram associated with the causal substructure and SLM generation system 500, such as the causal substructure and SLM generation system 334 of FIG. 3 according to some implementations. In the current example, the causal substructure and SLM generation system 500 may utilize the ART technique or process, discussed herein. The ART technique or process may be utilized to generate a seed SLMs (such as SLM 332 of FIG. 3). The ART technique may be utilized to generate smaller SLMs that may be configured to operate on resource constrained hardware components. In some cases, the ART technique may begin with a “small” unrefined LLM (e.g., an LLM having approximately 100 million to one billion parameters) or the SLM 502 in training. The SLM 502 may then utilize an ask-refine-trust process to learn the domain DAGs and/or the sub-domain DAG. In some cases, the ART technique may employ a larger LLM (e.g., the trusted LLM 504) to generate ranked answer data 506 to individual answers output by the SLM 502 that fail to match the input or training data (e.g., the question and sub-question data 508 and/or the initial prediction data 510). The SLM 502 may undergo multiple rounds or iterations of refinement (e.g., training via ranked answers to unmatching or unanswered questions) to generate the seed SLM (e.g., the SLM 332 of FIG. 3).

In the current example, a first LLM 512 (which may be the same as the trusted LLM 506 in some implementations) may receive variable descriptions 514 (e.g., variable descriptions from problem statements associated with the domain and/or sub-domain and/or the like) and domain data 516 (e.g., cause and effect description, user defined domain DAGs, and/or the like). The first LLM 512 may generate one or more Domain DAGs 514, such as discussed above with respect to FIG. 3. In some cases, the domain DAGs 514 may be utilized to generate question and sub-question data 516 that may be used to “ask” the SLM 502 questions during the “ask” phase of the ART process. Similarly, the system 500 may receive sub-domain question and answer data 518. The sub-domain question and answer data 518 may be related to the question and sub-question data 508, such as including answers to domain and/or sub-domain questions. The sub-domain question and answer data 518 may be utilized by the system 500 to generate initial prediction data 520, such as in some examples “answers” to the “asks”.

The system 500 may then determine for each question and/or sub-question associated with the question and sub-question data 508 if the SLM 502 answered correctly (e.g., in a manner that matches or complies with the initial prediction data 520), the answer is noted for the “refinement” phase and/or a next iteration of training. If the SLM 502 answered incorrectly (e.g., in a manner that deviates from and/or does not match or comply with the initial prediction data 520), the trusted LLM 506 may, based at least in part on the question and sub-question data 508, the initial prediction data 520, and the list of incorrectly answered question, generate answer data 522. In the current example, the answer data 522 may be provided back to the first LLMs 512 for generation of new domain DAGS 514 and thus new question and sub question data 508 and to the SLM 502 for use in training or refining future outputs of the SLM 502. In other examples, the answer data 522 may also be utilized to update the initial prediction data 520.

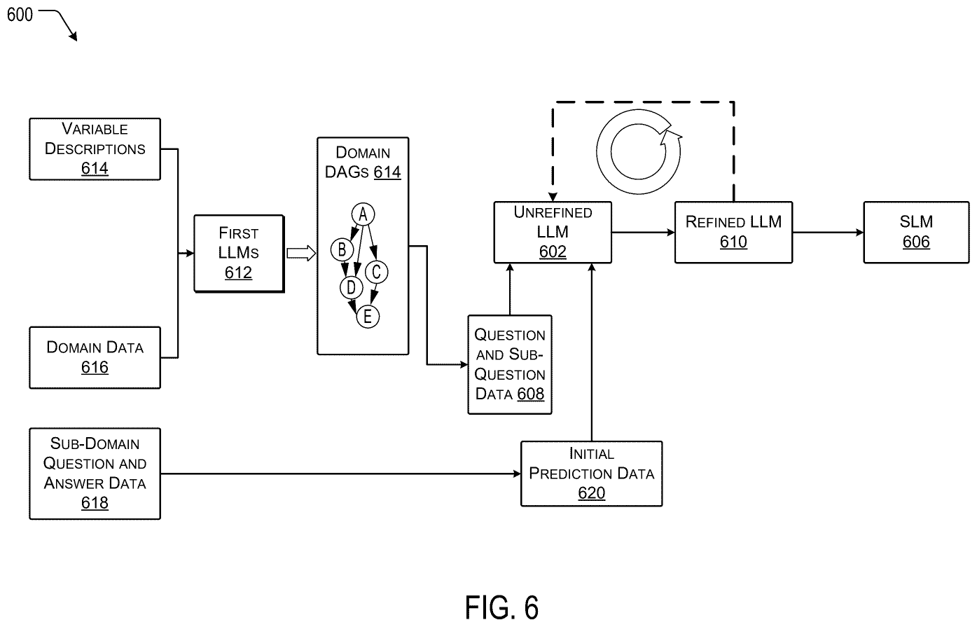

FIG. 6 is yet another example block diagram associated with the causal substructure and SLM generation system 600, such as the causal substructure and SLM generation system 334 of FIG. 3, according to some implementations. In the current example, the causal substructure and SLM generation system 600 may apply the DISTILL technique or process, as discussed above with respect to FIG. 3, to generate the SLM 606.

In the current example, a first LLM 612 may receive variable descriptions 614 (e.g., variable descriptions from problem statements associated with the domain and/or sub-domain and/or the like) and domain data 616 (e.g., cause and effect description, user defined domain DAGs, and/or the like). The first LLM 612 may generate one or more Domain DAGs 614, such as discussed above with respect to FIG. 3. In some cases, the domain DAGs 614 may be utilized to generate question and sub-question data 608 that may be used to “distill” the SLM 606. For instance, the system 600 may receive sub-domain question and answer data 618. The sub-domain question and answer data 618 may be related to the question and sub-question data 608, such as including answers to domain and/or sub-domain questions. The sub-domain question and answer data 618 may be utilized by the system 600 to generate initial prediction data 620, such as in some examples desired output data of the SLM 606. The unrefined LLM 602 may then generate outputs which together with the question and sub-question data 608 and the initial prediction data 620, may be used to generate a more refined LLM 610 until ultimately the SLM 606 is generated.

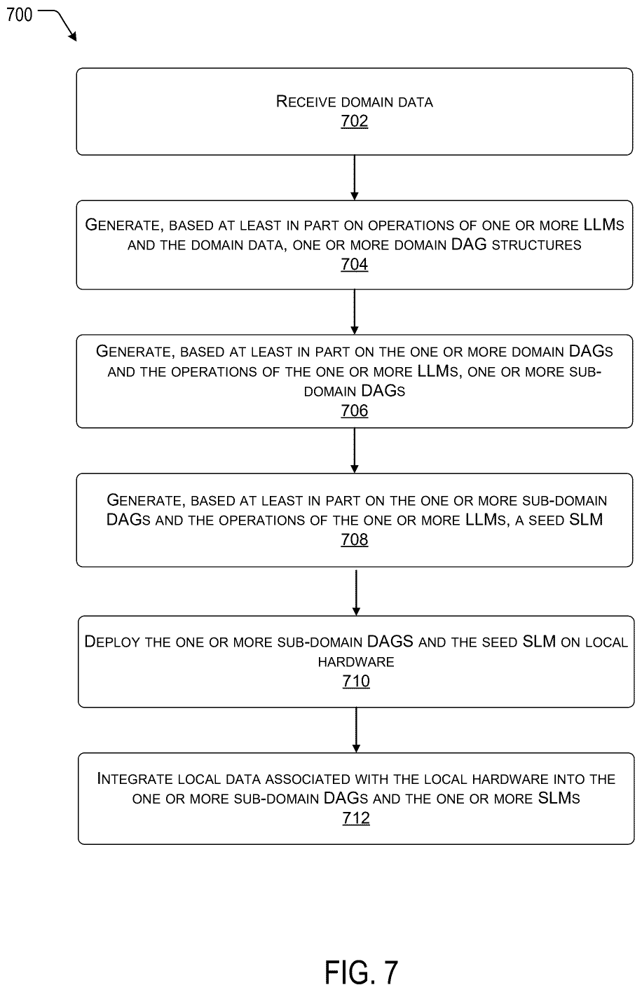

FIG. 7 is a flow diagram illustrating example processes associated with the generation and deployment of savant language models discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 7 is a flow diagram illustrating an example process 700 associated with the generation and deployment of savant language models, according to some implementations. As discussed above, a cloud-based system may generate a deployable model that includes a SLM and a sub-domain DAG to provide a machine learning model that has both a semantic memory and an episodic memory. The deployable model may then be installed on local hardware systems and operated within a closed computational environment.

At 702, the cloud-based system may receive domain data. For example, the domain data may be received from a third-party source and related to a specific field, industry, locale or the like. In some cases, the domain data may be text data, preexisting expert knowledge data, multi-modal data streams (e.g., text, images, sensor data), and the like.

At 704, the cloud-based system may generate, based at least in part on operations of one or more LLMs and the domain data, one or more domain DAG structures. For example, the one or more LLMs may be a first set of LLMs trained to integrate domain data and output DAGs. In some examples, the first set of LLMs may be configured to receive the output DAG as an input together with additional domain data to further refine the DAGs for the given domain.

At 706, the cloud-based system may generate, based at least in part on the one or more domain DAGs and the operations of the one or more LLMs, one or more sub-domain DAGs. In some cases, the one or more LLMS may be the first set of LLMs of 704. However, in other examples a second set of LLMs trained to output sub-domain DAGs may be utilized to generate the sub-domain DAGs based on input data including the domain DAGs and experiential data associated with the sub-domain.

At 708, the cloud-based system may generate, based at least in part on the one or more sub-domain DAGs and the operations of the one or more LLMs, a seed SLM. As discussed herein, the system may utilize the first set of LLMs and/or the second set of LLMs together with the sub-domain DAGs to generate an initial seed SLM that may be deployed and operate within a reduced or limited computational resources environment.

At 710, the cloud-based system may deploy the one or more sub-domain DAGS and the seed SLM on local hardware (e.g., as a deployable model). For example, the one or more sub-domain DAGS and the seed SLM may be installed, downloaded, uploaded, or otherwise hosted by the local hardware.

At 712, the deployable model may begin operation on the local hardware and integrate local data associated with the local hardware into the one or more sub-domain DAGs and the one or more SLMs. For example, the SLM may self-train and update the sub-domain DAGs using the local data as operations are performed. In this manner, the deployable model may become more specialized for the sub-domain, task, process, environment, and operations of the local hardware.

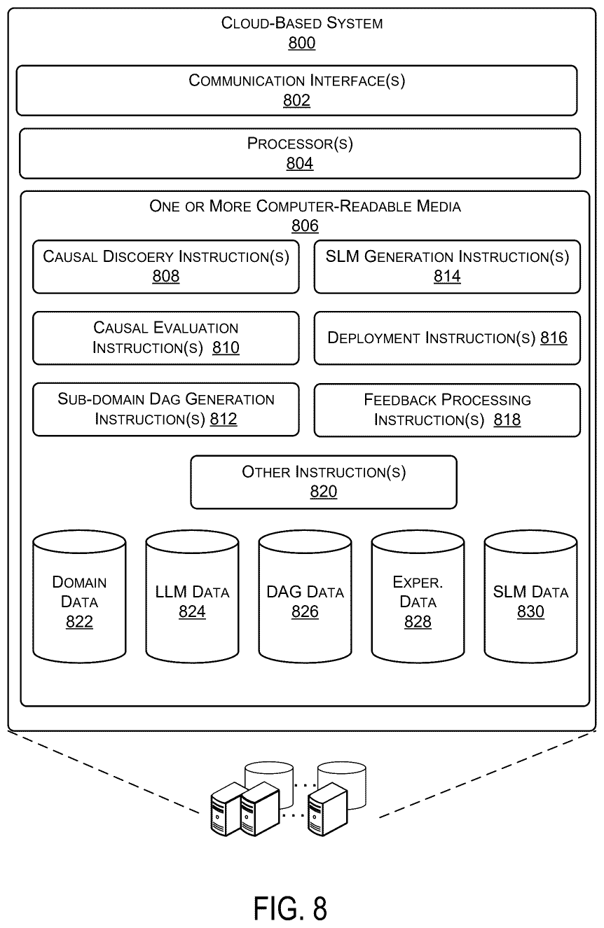

FIG. 8 is an example cloud-based system 800 that may implement the techniques described herein according to some implementations. The cloud-based system 800 may include one or more communication interface(s) 802 that enable communication between the cloud-based system 800 and one or more other local or remote computing device(s) or remote services. For instance, the communication interface(s) 802 may facilitate communication with other proximate sensor systems and/or other facility systems. The communications interfaces(s) 802 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The cloud-based system 800 may include one or more processors 804 and one or more computer-readable media 806. Each of the processors 804 may itself comprise one or more processors or processing cores. The computer-readable media 806 is illustrated as including memory/storage. The computer-readable media 806 may include volatile media (such as random access memory (RAM)) and/or nonvolatile media (such as read only memory (ROM), Flash memory, optical disks, magnetic disks, and so forth). The computer-readable media 806 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Several modules such as instructions, data stores, and so forth may be stored within the computer-readable media 806 and configured to execute on the processors 804. For example, as illustrated, the computer-readable media 806 stores causal discovery instructions 808, causal evaluation instructions 810, sub-domain DAG generation instructions 812, SLM generation instructions 814, deployment instructions 816, feedback processing instruction 818, as well as other instructions 820, such as an operating system. The computer-readable media 806 may also be configured to store data, such as domain data 822, large language models 824, DAGs data 826, experimental data 828, SLM data 830 as well as other data.

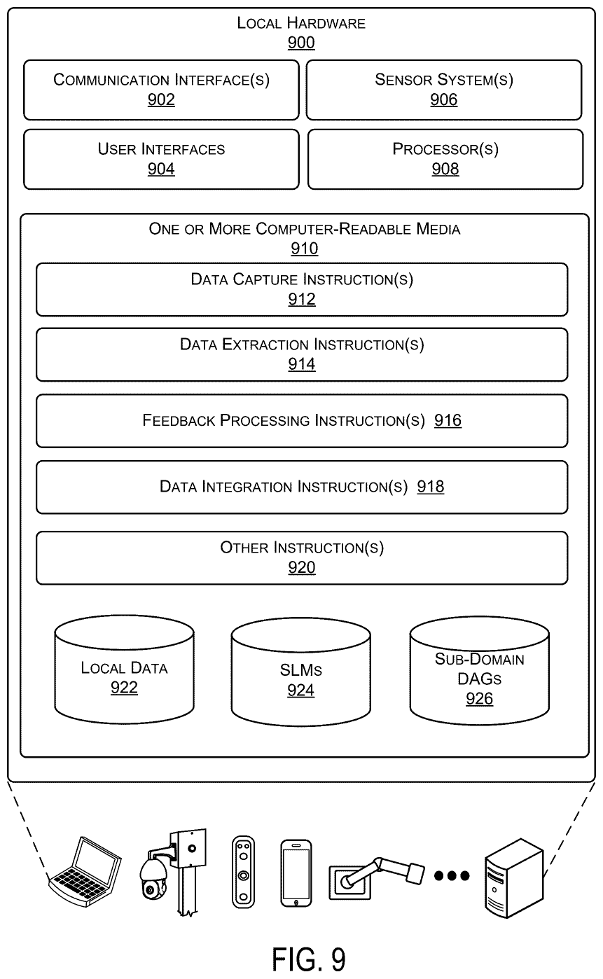

FIG. 9 is an example local hardware device 900 for deployment of a savant language model according to some implementations. The local hardware device 900 may include one or more communication interface(s) 902 (also referred to as communication devices and/or modems), one or more user interfaces 904, and one or more sensor system(s) 906.

The one or more communication interfaces(s) 902 may enable communication between the local hardware 900 and one or more other local or remote computing device(s) or remote services, such as a cloud-based system of FIGS. 1-5 for deployment of the deployable model, as discussed herein. For instance, the communication interface(s) 902 may facilitate communication with other proximate sensor systems, a central control system, or other facility systems. The communications interfaces(s) 902 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more user interface 904 may include one or more input devices (e.g., keyboard, mouse, or the like) as well as one or more output devices (e.g., a display). In some cases, the user interface 904 may include an input/output device, such as a touch enabled display. In other examples, the user interface 904 may include natural language processing systems, such as voice interactive systems.

The one or more sensor system(s) 906 may be configured to capture the local data 922 associated the local hardware device 900. In at least some examples, the sensor system(s) 906 may include thermal sensors, time-of-flight sensors, location sensors, LIDAR sensors, radar sensors, sonar sensors, infrared sensors, cameras (e.g., RGB, IR, intensity, depth, etc.), microphone sensors, environmental sensors (e.g., temperature sensors, humidity sensors, light sensors, pressure sensors, etc.), and the like. In some examples, the sensor system(s) 906 may include multiple instances of each type of sensors. For instance, camera sensors may include multiple cameras disposed at various locations.

The local hardware device 900 may include one or more processors 908 and one or more computer-readable media 910. Each of the processors 908 may itself comprise one or more processors or processing cores. The computer-readable media 910 is illustrated as including memory/storage. The computer-readable media 910 may include volatile media (such as random access memory (RAM)) and/or nonvolatile media (such as read only memory (ROM), Flash memory, optical disks, magnetic disks, and so forth). The computer-readable media 910 may include fixed media (e.g., RAM, ROM, a fixed hard drive, and so on) as well as removable media (e.g., Flash memory, a removable hard drive, an optical disc, and so forth). The computer-readable media 910 may be configured in a variety of other ways as further described below.

Several modules such as instructions, data stores, and so forth may be stored within the computer-readable media 910 and configured to execute on the processors 908. For example, as illustrated, the computer-readable media 910 stores data capture instructions 912, data extraction instructions 914, feedback processing instructions 916, data integration instructions 918, as well as other instructions 920, such as an operating system. The computer-readable media 910 may also be configured to store data, such as local data 922 (e.g., user input/output data, sensor data, operational data, and the like), SLM models 924, sub-domain DAGs 926, and the like.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### Example Clauses

A. A method comprising: receiving, at a cloud-based computational resources, first data associated with a first domain; inputting, by the cloud-based computational resources, the first data into a large language model and receiving as an output of the large language model a first causal structure representing the first domain, the large language model trained on data associated with various domains and causal relationships between nodes of various causal structure representing the various domains; receiving, at the cloud-based computational resources, second data associated with a first sub-domain of the first domain; generating, at the cloud-based computational resources and based at least in part on the second data and the first causal structure, a second causal structure representing the sub-domain, the second causal structure having fewer nodes than the first causal structure; generating, at the cloud-based computational resources and based at least in part on the second data and the second causal structure, a savant language models associated with the sub-domain; and outputting, by the cloud-based computational resources, a deployable model including the second causal structure and the savant language model.
B. The method of A, wherein outputting the deployable model further comprises installing the deployed model on local hardware and the method further comprises: generating, at the local hardware, local data associated with operations of the local hardware; and inputting the local data into the savant language model and receiving as an output the savant language model associated with the operations of the local hardware, the savant language model accessing the second causal structure with respect to generating the output data.
C. The method of B, wherein the local data includes user input and sensor data captured by sensor systems associated with the local hardware.
D. The method of B, wherein the local hardware is operating in a closed environment without access to remote systems.
E. The method of B, further comprising: adjusting at least one node of the second causal structure based at least in part on the local data; and inputting the local data into the savant language model as additional training data to adjust the savant language model for the operations of the local hardware.
F. The method of E, further comprising: generating, by the deployable model on the local hardware, feedback data associated with the second causal structure and the savant language model; and providing the feedback data to the cloud-based computational resources.
G. The method of F, further comprising: adjusting, at the cloud-based computational resources, at least one node of the first causal structure based at least in part on the feedback data; and inputting the feedback data into the large language model as additional training data to adjust the large language model based at least in part on the operations of the second causal structure and the savant language model.
H. The method B, wherein the local hardware is one or more of: an edge computing device; a sensor system; or an autonomous system.
I. The method of A, wherein: the large language model is a first large language model; and generating the second causal structure representing the sub-domain further comprises inputting the second data and the first causal structure into a second large language model and receiving as an output of the second large language model the second causal structure, the second large language model trained on data associated with various domains, sub-domains, and causal relationships between nodes of various causal structure representing the various domains and sub-domains.
J. The method of A, wherein the first causal structure is a first directed acyclic graph representing the domain and the second causal structure is a second directed acyclic graph having fewer nodes than the first directed acyclic graph and representing the sub-domain.
K. The method of A, wherein the savant language model is a seed savant language model that is configured to self-train when deployed on local hardware as part of the deployable model.
L. The method of A, wherein generating the savant language models associated with the sub-domain includes at least one of: a group relative policy optimization (GRPO) process; an ask-refine-trust (ART) process, or a train-distill (DISTILL) process.
M. The method of A, wherein generating the savant language models associated with the sub-domain includes an iterative process.
N. The method of A, wherein generating the savant language models associated with the sub-domain includes refining an unrefined large language model into the savant language model based at least in part on initial prediction data generated from use redefined sub-domain question and answer data.
O. A system for receiving experiential data and outputting a deployable model including a sub-domain causal structure and a savant language model comprising: a first causal structure representing a domain as a series of nodes and directional and causal connections, the domain including the sub-domain; a first large language model trained on data associated with various domains and causal relationships between nodes of various causal structure representing the various domains, the first large language model to receive domain data and output causal structures; and a second large language model to receive the experiential data as an input and output the deployable model including the sub-domain causal structure and the savant language model, the second large language model trained on data associated with various domains, sub-domains, and causal relationships between nodes of various causal structure representing the various domains and sub-domains, the first causal structure accessible by the second large language model when generating the deployable model.
P. The system of O, wherein the first causal structure is a directed acyclic graph.
Q. The system of O, wherein the second causal structure is a directed acyclic graph.
R. The system of O, further comprising a deployment component to install the deployable model on local hardware.
S. The system of O, wherein the first causal structure, the first large language model, and the second large language model operate in a training feedback loop.
T. A deployable model comprising: at least one causal structure representing a sub-domain of a larger domain; and a savant language model generated as an output of a large language model informed by at least one second causal structure representing the larger domain.
U. The deployable model of T, wherein the savant language model is configured to self-train on local data generated by local hardware when deployed.
V. The deployable model of T, wherein the savant language model is configured to adjust the least one causal structure based on local data generated by local hardware when deployed.
W. The deployable model of V, wherein the at least one causal structure is a directed acyclic graph.
X. A system outputting a deployable model including a sub-domain causal structure and a savant language model comprising: a first causal structure representing a domain as a series of nodes and directional and causal connections, the domain including the sub-domain; a domain large language model trained on data associated with various domains and causal relationships between nodes of various causal structure representing the various domains, the domain large language model to receive domain data and output causal structures; and a base large language model configured to be tuned, based at least in part on the causal structures and input data associated with the domain, into the savant language model.
Y. The system of claim X, further comprising: one or more checker systems to: evaluate one or more proposals output by the base large language model to generate prompt feedback; and input the prompt feedback into the base large language model; and wherein base large language model is tuned to the savant language model based at least in part on the prompt feedback.
Z. The system of claim X, wherein the input data include question and sub-question data associated with the domain and sub-domain and initial prediction data representing answers to the question and sub-question data associated with the domain data.
AA. The system of claim X, further comprising: a trusted large language model to generate, based at least in part on outputs of the base large language model and answer data and to input the answer data into the base large language model as part of a tuning process.
AB. The system of claim X, wherein the savant language model is substantially similar in size with respect to the base large language model.
AC. The system of claim X, wherein the savant language model is substantially smaller in size with respect to the base large language model.

While the example clauses described above are described with respect to one particular implementation, it should be understood that, in the context of this document, the content of the example clauses can also be implemented via a method, device, system, a computer-readable medium, and/or another implementation. Additionally, any of examples A-AC may be implemented alone or in combination with any other one or more of the examples A-AC.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, at a cloud-based computational resources, first data associated with a first domain;
inputting, by the cloud-based computational resources, the first data into a large language model and receiving as an output of the large language model a first causal structure representing the first domain, the large language model trained on data associated with various domains and causal relationships between nodes of various causal structures representing the various domains;
receiving, at the cloud-based computational resources, second data associated with a first sub-domain of the first domain;
generating, at the cloud-based computational resources and based at least in part on the second data and the first causal structure, a second causal structure representing the sub-domain, the second causal structure having fewer nodes than the first causal structure;
generating, at the cloud-based computational resources and based at least in part on the second data and the second causal structure, a savant language models associated with the sub-domain; and
outputting, by the cloud-based computational resources, a deployable model including the second causal structure and the savant language model.

2. The method of claim 1, wherein outputting the deployable model further comprises installing the deployed model on local hardware and the method further comprises:
generating, at the local hardware, local data associated with operations of the local hardware; and
inputting the local data into the savant language model and receiving as an output the savant language model associated with the operations of the local hardware, the savant language model accessing the second causal structure with respect to generating the output data.

3. The method of claim 2, wherein:
the local data includes user input and sensor data captured by sensor systems associated with the local hardware; and
the local hardware is operating in a closed environment without access to remote systems.

4. The method of claim 2, further comprising:
adjusting at least one node of the second causal structure based at least in part on the local data; and
inputting the local data into the savant language model as additional training data to adjust the savant language model for the operations of the local hardware.

5. The method of claim 4, further comprising:
generating, by the deployable model on the local hardware, feedback data associated with the second causal structure and the savant language model; and
providing the feedback data to the cloud-based computational resources.

6. The method of claim 5, further comprising:
adjusting, at the cloud-based computational resources, at least one node of the first causal structure based at least in part on the feedback data; and
inputting the feedback data into the large language model as additional training data to adjust the large language model based at least in part on the operations of the second causal structure and the savant language model.

7. The method of claim 1, wherein generating the savant language models associated with the sub-domain includes at least one of:
a group relative policy optimization (GRPO) process;
an ask-refine-trust (ART) process, or
a train-distill (DISTILL) process.

8. The method of claim 1, wherein generating the savant language models associated with the sub-domain includes an iterative process.

9. The method of claim 1, wherein:
the large language model is a first large language model; and
generating the second causal structure representing the sub-domain further comprises inputting the second data and the first causal structure into a second large language model and receiving as an output of the second large language model the second causal structure, the second large language model trained on data associated with various domains, sub-domains, and causal relationships between nodes of various causal structure representing the various domains and sub-domains.

10. The method of claim 1, wherein the first causal structure is a first directed acyclic graph representing the domain and the second causal structure is a second directed acyclic graph having fewer nodes than the first directed acyclic graph and representing the sub-domain.

11. The method of claim 1, wherein generating the savant language models associated with the sub-domain includes refining an unrefined large language model into the savant language model based at least in part on initial prediction data generated from use redefined sub-domain question and answer data.

12. A system outputting a deployable model including a sub-domain causal structure and a savant language model comprising:
a first causal structure representing a domain as a series of nodes and directional and causal connections, the domain including the sub-domain;
a domain large language model trained on data associated with various domains and causal relationships between nodes of various causal structure representing the various domains, the domain large language model to receive domain data and output causal structures; and
a base large language model configured to be tuned, based at least in part on the causal structures and input data associated with the domain, into the savant language model.

13. The system of claim 12, further comprising:
one or more checker systems to:
evaluate one or more proposals output by the base large language model;
generate prompt feedback; and
input the prompt feedback into the base large language model; and
wherein base large language model is tuned to the savant language model based at least in part on the prompt feedback.

14. The system of claim 12, wherein the input data include question and sub-question data associated with the domain and sub-domain and initial prediction data representing answers to the question and sub-question data associated with the domain data.

15. The system of claim 12, further comprising:
a trusted large language model to generate, based at least in part on outputs of the base large language model answer data and to input the answer data into the base large language model as part of a tuning process.

16. The system of claim 12, wherein the savant language model is substantially similar in size with respect to the base large language model.

17. The system of claim 12, wherein the savant language model is substantially smaller in size with respect to the base large language model.

18. A deployable model comprising:
at least one causal structure representing a sub-domain of a larger domain; and
a savant language model generated as an output of a large language model informed by at least one second causal structure representing the larger domain.

19. The deployable model of claim 18, wherein the savant language model is configured to self-train on local data generated by local hardware when deployed.

20. The deployable model of claim 18, wherein the savant language model is configured to adjust the least one causal structure based on local data generated by local hardware when deployed.
